(19) United States
(12) Patent Application Publication
(10) Pub. No.: US 2004/0068048 A1
(43) Pub. Date: Apr. 8, 2004

(54) Low abrasive rubber composition and associated method of manufacturing the same

(76) Inventors: Sanford F. Giles, Chicago, IL (US); Alex T. Koshy, Morton Grove, IL (US)

Correspondence Address: BARNES & THORNBURG, P.O. BOX 2786, CHICAGO, IL, 60690-2786, US

(21) Appl. No.: 10/266,791

(22) Filed: Oct. 7, 2002

(51) Int. Cl. C08L 83/00

(52) U.S. Cl. 524/588

(57) ABSTRACT

A silicone rubber composition which includes a silicone polymer component and a filler material which is substantially devoid of free-SiO₂ is described.

### FIELD

The present invention relates generally to rubber compositions, and more particularly to a low abrasive rubber composition.

### BACKGROUND

When manufacturing rubber, typically fillers, such as reinforcing fillers, semi-reinforcing fillers, and/or extending fillers are added to the elastomeric compositions used in the manufacturing process. These fillers help improve various physical properties of the composition, such as, viscosity, modulus, tangent delta, and the like. For example, fillers such as silica and/or carbon black are added to improve on the aforementioned physical properties of the rubber compositions. However, a draw back to utilizing conventional fillers is that they tend to be abrasive, and thus increase the abrasiveness of the composition to which they are added. Increasing the abrasiveness of these rubber compositions results in a greater amount of wear and tear on the machines utilized to process such compositions. For example, during the manufacturing process machine parts, such as augurs, mixers, rams, screws, and rollers, are exposed to the abrasive rubber compositions. Accordingly, these machines tend to suffer from a great deal of wear and must be periodically serviced or replaced. Servicing or replacing these machines and/or their parts can be expensive, and therefore can increase the manufacturing cost of producing rubber. Therefore, a rubber composition having a decreased abrasiveness is desirable.

### SUMMARY

According to one illustrative embodiment, there is provided a silicone rubber composition. The silicone rubber composition includes (i) a silicone polymer component and (ii) a filler material which is substantially devoid of free SiO₂.

According to another illustrative embodiment, there is provided a silicone rubber composition. The silicone rubber composition includes (i) a silicone polymer component and (ii) Nepheline Syenite.

According to yet another illustrative embodiment, there is provided a silicone rubber composition which is substantially devoid of quartz.

According to still another illustrative embodiment there is provided a silicone rubber composition. The silicone rubber composition includes (i) a silicone polymer component and (ii) a filler material which includes Nepheline Syenite.

According to yet another illustrative embodiment there is provided a silicone rubber composition which (i) is substantially devoid of free SiO₂ and (ii) includes a substantial amount of (A) KAISi₃O₈ and (B) a silicone polymer component.

According to still another illustrative embodiment there is provided a method of producing a silicone rubber composition which includes a silicone polymer component. The method includes adding Nepheline Syenite to the silicone polymer component.

### BRIEF DESCRIPTION OF THE DRAWINGS

FIG. 1 is a scanning electron micrograph of an illustrative sample of Nepheline Syenite filler (i.e. Minex 4) and the distribution of particle shapes contained therein; and

FIG. 2 is a graphical illustration of the cumulative volume percent verses particle diameter of various Minex grades.

### DETAILED DESCRIPTION OF THE DISCLOSURE

While the invention is susceptible to various modifications and alternative forms, specific exemplary embodiments thereof have been shown by way of example in the drawings and will herein be described in detail. It should be understood, however, that there is no intent to limit the invention to the particular forms disclosed, but on the contrary, the intention is to cover all modifications, equivalents, and alternatives falling within in the spirit and scope of the invention.

As discussed above, to achieve useful engineering properties (e.g. enhanced physical properties such as tensile strength), it is desirable to reinforce a rubber composition by the addition of an effective amount of one or more fine, high surface area filler materials. However, as discussed herein, it is advantageous to utilize a filler material which is less abrasive as compared to some conventional filler materials, such as free-silica containing filler materials. Accordingly, the rubber compositions described herein include an effective amount of a relatively less abrasive filler material, such as a relatively less abrasive reinforcing filler, a relatively less abrasive a semi-reinforcing filler, and/or a relatively less abrasive extending filler. An example of a relatively less abrasive filler material which can be utilized in the rubber compositions described herein includes, but is not limited to, filler materials which contain ground Nepheline Syenite, or filler materials which are entirely made up of ground Nepheline Syenite.

Nepheline Syenite is an anhydrous sodium potassium alumino silicate. Mineralogically, Nepheline Syenite is an igneous rock combination of nepheline, microcline, albite and minor minerals like mica, hornblende and magnetite. For example, Nepheline Syenite is a medium to coarse-grained, light- to medium-gray, igneous rock that includes a substantial amount of a silicate mineral called orthoclase (KAISi₃O₈) and has a granite like appearance. Nepheline Syenite is distinguished from granite by being substantially devoid of free-SiO₂. What is meant herein by “substantially devoid of free-SiO₂” is that the material contains no more than a deminimus amount of free-SiO₂ which may be present as a result of the material being exposed to its environment during, for example, its manufacture, processing, packaging, and transportation.

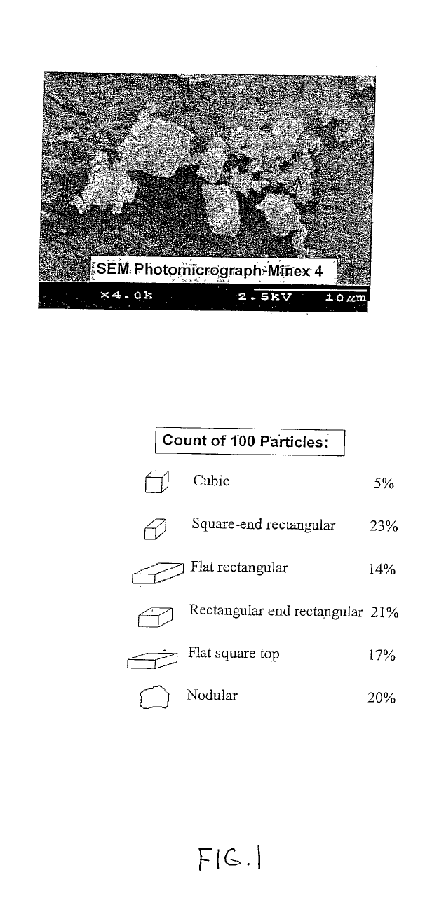

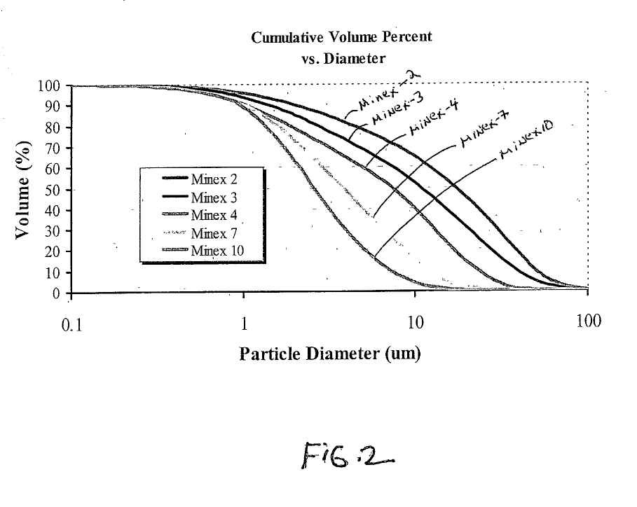

One filler material based upon ground Nepheline Syenite which can be utilized in the rubber compositions described herein is known as Minex. Minex is commercially available from, for example, Unimin Canada Ltd. located in Havelock, Ontario Canada. One illustrative scanning electron micrograph of Minex is shown in FIG. 1. FIG. 1 also sets forth an illustrative example of a particle shape distribution of a Minex sample. FIG. 2 shows a graphical illustration of the cumulative volume percent verses particle diameter of various Minex grades. It should be appreciated that Minex grades are ground and air-classified from Nepheline Syenite ore which is substantially devoid of free-silica. In particular, the Nepheline Syenite ore used to produce Minex is a blend of three feldspathic minerals, i.e. Albite (Na₂O.Al₂O₃.6SiO₂), Microcline (K₂O.3Al₂O₃.6SiO₂), and Nepheline (Na₂O.K₂O.Al₂O₃.4SiO₂). Properties of Minex Nepheline Syenite include a density of 21.7 lbs/gal, a Mohs hardness of 6.0, a brightness of (tappi) 85-91, a % oil abs. (ASTM D281) 23-34, a refractive index of 1.53, and a pH (10% slurry) of 9.5-10. Furthermore, various examples of Minex particle sizes (microns) which can be utilized in the rubber compositions described herein are shown below in Table 1.

TABLE 1

| | Median particle Size |
|---|---|
| Minex Grade | (microns) |
| 10 | 2.1 |
| 7 | 3.5 |
| 4 | 6.8 |
| 3 | 10.8 |
| 2 | 14.3 |
| S-10 | 2.6 |
| S-20 | 4.5 |
| S-30 | 5.5 |
| S-40 | 11.0 |

The amount of filler material present in the rubber compositions described herein is the amount required to fulfill the physical property requirements of its particular application which can be determined by one of ordinary skill in the art utilizing routine experimentation. For example, the low abrasion rubber compositions described herein can include about 1 part to about 100 parts by weight of filler material for every 100 parts by weight of a rubber polymer component. For example, Tables 2, 3, and 4 set forth illustrative low abrasion rubber compositions which utilize Minex-7 as a filler material.

TABLE 2

| Rubber Formulation Component | Quantity in Pounds |
|---|---|
| SE 6260 | 20 |
| SE 6035 | 30 |
| VAROX DBPH-50 | 1 |
| Minex-7 | 20 |
| Black Master Batch | 0.5 |
| Red Master Batch | 0.5 |

TABLE 3

| Rubber Formulation Component | Quantity in Grams |
|---|---|
| SE 6035 | 250 |
| XE 20-6016US | 250 |
| Minex-7 | 500 |
| Huber Sil 162 | 70 |
| Black Master Batch | 15 |
| Red Master Batch | 5 |
| DBPH 50 | 5 |
| HT-1 | 2.5 |
| MRA-1 | 1.5 |

TABLE 4

| Rubber Formulation Component | Quantity in Grams |
|---|---|
| SE 6035 | 500 |
| Minex-7 | 500 |
| Huber Sil 162 | 70 |
| Black Master Batch | 15 |
| Red Master Batch | |
| DBPH 50 | 5 |
| HT-1 | 2.5 |
| MRA-1 | 1.5 |

Note that SE 6260, SE 6035, and XE 20-6016US are designations of well known commercially available rubber polymer components. VAROX and DBPH-50 are designations of well known commercially available cross linking agents. Black Master Batch and Red Master Batch are designations of well known commercially available coloring agents. Huber Sil 162 is the designation of a well known commercially available reinforcing filler. HT-1 is the designation of a well known commercially available heat additive, and MRA-1 is the designation of a well known commercially available mold release additive.

Therefore, it should be appreciated that rubber compositions described herein include compositions which (i) have Nepheline Syenite, e.g. Minex, added thereto as the filler material and (ii) are not subjected to a process which purposefully adds free-SiO₂ thereto. Accordingly, these rubber compositions are substantially devoid of free-SiO₂. However, it is also contemplated that that rubber compositions described herein include compositions which (i) have Nepheline Syenite, e.g. Minex, added thereto as the filler material and (ii) are subjected to a process which purposefully adds thereto some amount of a filler material which contains free-SiO₂, e.g. SIL-CO-SIL® or MIN-U-SIL®. These rubber compositions will contain both Nepheline Syenite and some amount of material which contains free-SiO₂. Accordingly, these rubber compositions will contain more than a deminimus amount of free-SiO₂ and thus are not substantially devoid of free-SiO₂. However, it is contemplated that these rubber compositions, while not being substantially devoid of free-SiO₂, will still benefit from some of the advantages of the present disclosure discussed below.

Relative to conventional rubber compositions which include filler materials that contain free-SiO₂ and/or carbon black, the rubber compositions described herein which are substantially devoid of free-SiO₂ are less abrasive due to the addition of a filler material which is substantially devoid of free-SiO₂ (e.g. Nepheline Syenite). In addition, the rubber compositions described herein which are manufactured with a decreased amount of free-SiO₂ and/or carbon black due to the addition of an amount of a filler material which is substantially devoid of free-SiO₂, such as Nepheline Syenite, are also less abrasive relative to conventional rubber compositions. Accordingly, the rubber compositions described herein cause less wear and tear on exposed machinery components (e.g. augurs) which in turn helps to reduce the maintenance costs for such machines. In addition, it should be appreciated that utilizing a filler material which is substantially devoid of free-SiO₂ can provide health benefits. In particular, materials containing free-silica has been associated with lung problems, such as silicoses. Accordingly, as described herein, using a filler material which is substantially devoid of free-silica may help decrease the health problems associated with materials which contain free-silica.

As mentioned above, the rubber compositions described herein include a polymer component. For example, one polymer component which can be utilized in the rubber compositions described herein is a silicone polymer component which yields a silicone rubber composition. However, it should be appreciated that other polymer components are contemplated, for example, organic polymer components which yield organic rubber compositions. The silicone polymer components which can be utilized in the aforementioned silicone rubber compositions include, for example, commercially available vinyl-containing silicone polymer components. However, it should be appreciated that the present disclosure is not limited to vinyl-containing silicone polymer components, and other silicone polymer components are contemplated.

With respect to vinyl-containing silicone polymer components which can be utilized in the silicone rubber compositions described herein, these include, but are not limited to, vinyl-containing polyorganosiloxanes which are made up of repeating units of diorganosiloxane units, monoorganosilsesquioxane units, and triorganosiloxy units. Other siloxane units, for example SiO₂ units, can also be present if the properties described herein can be obtained. The organic radicals of the polyorganosiloxane can include, for example, monovalent hydrocarbon radicals such as methyl, ethyl, propyl, isopropyl, butyl, octyl, phenyl, vinyl, allyl, and cyclohexyl, or monovalent halogenated hydrocarbon radicals such as chloropropyl, 3,3,3-trifluoropropyl. and 2-(perfluorobutyl)ethyl. For example, one polyorganosiloxane which can be utilized in the silicone rubber compositions described herein contains at least about 0.1 weight percent vinyl radicals based on the total weight of the polyorganosiloxane. Examples of polyorganosiloxanes having exemplary amounts of vinyl radicals are those having the ASTMD-1418 classification “VMQ”. For example, one vinyl-containing silicone polymer component which can be utilized in the silicone rubber compositions is Methyl Vinyl Silicone.

The silicone rubber compositions described herein can also include an effective amount of a heat stability additive. What is meant herein by a heat stability additive is a substance that when added to the silicone rubber composition increases the silicone rubber composition's resistance to thermal degradation. For example, heat stability additives which can be utilized in the silicone rubber compositions described herein include, but are not limited to, iron oxides, titania, cerium oxides, fatty acid cerium salts, magnesium oxides, manganese oxides, and metallic zirconates. In particular, the heat stability additive HT1 which is commercially available from Dow Corning located in Midland, Mich., can be utilized in silicone rubber compositions described herein. In addition the heat stability additive HTM3 which is commercially available from Walker Silicone located in Adrian, Mich., can be utilized in silicone rubber compositions described herein.

The amount of heat stability additive present in the silicone rubber composition is the amount required to effectively fulfill the heat resistant property requirements of its application. For example, the heat stability additive can be present in the silicone rubber composition at about 1 part to about 2 parts by weight of heat stability additive for every 100 parts by weight of the vinyl-containing silicone polymer component.

Now turning to the processing of the silicone rubber compositions described herein, preferably, these compositions are cured with an organic peroxide. Organic peroxides fall into two broad categories according to their ability to crosslink just vinyl groups or both methyl and vinyl groups. The dialkyl peroxides such as dicumyl peroxides fall into the former category and are termed “vinyl specific” while the diacyl peroxides such as benzoyl peroxide fall in the latter category. Most peroxides are available as a liquid (90%-98% active), as powders (40%-50% active), or as pastes made from silicone fluids and gums (20%-80% active) to facilitate handling and dispersion. Examples of peroxides which can be utilized in the silicone rubber compositions described herein include, but are not limited to, those set forth below in Table 5.

TABLE 5

| | | | | Typical | |
|---|---|---|---|---|---|
| | Commercial | | | Molding | Recommended |
| Peroxides | Grades | Form | % | Temperature | Use |
| Bis (2,4 | Cadox ® TS-50 | 50% | 1.2 | 104-132 C. | Hot Air |
| Dichlorobenzoyl) | Or | Active | | (220-270 F.) | Vulcanization |
| Peroxide | Luperco ® CST | Paste | | | |
| DCBP-50 | | | | | |
| Benzoyl | Cadox ® TS-50 | 50% | 0.8 | 116-138 C. | Molding |
| Peroxide | Or | Active | | (240-280 F.) | Steam Curing |
| BP-50 | Luperco ® CST | Paste | | | |
| DiCumyl | DiCup ® 40C | 40% | 1.0 | 154-177 C. | Molding Thick |
| Peroxide | | Active | | (310-360 F.) | Sections, |
| | | Powder | | | Bonding, |
| | | | | | Steam Curing |
| 2,5-DiMethyl- | Varox ® | 50% | 0.8 | 166-182 C. | Molding Thick |
| 2,5 Di(t-butyl peroxy) | Or | Active | | (330-360 F.) | Sections, |
| Hexane | DBPH-50 | Powder | | | Bonding, |
| | Lupersol 101 | 100% | 0.4 | | Steam Curing |
| | | Active | | | |
| | | Liquid | | | |

For molded silicone rubber composition products the organic peroxide 2,5dimethyl-2,5-di(t-buytl-peroxy) hexane can be utilized in the curing process. In particular, about 0.8 parts to about 1.2 parts by weight of 2,5-dimethyl-2,5-di(t-buytl-peroxy) hexane for every 100 parts by weight of the vinyl-containing silicone polymer component can be used to cure the silicone rubber composition. With respect to extruded silicone rubber composition products, 2,5-dimethyl-(2,5 di (benzoylperoxy) hexane can be utilized in the curing process. In particular, about 1 parts to about 1.2 parts by weight of 2,5-dimethyl-(2,5 di (benzoylperoxy) hexane for every 100 parts by weight of the vinyl-containing silicone polymer component can be used to cure the silicone rubber composition. Furthermore, it should be understood that, preferably, the peroxide having the highest temperature decomposition point that is suitable for a particular manufacturing and/or curing process be utilized.

The silicone rubber compositions described herein can also include any of a number of appropriate process aids and or coloring agents as desired. Process aids are reactive silicone fluids which chemically modify the surface of the silica filler materials to reduce their association with the silicone polymer component. These process aids enhance the processability of the vinyl-containing silicone component by, for example, aiding in the dispersion of filler material.

An example of one silicone rubber composition described herein includes about 100 parts of vinyl-containing silicone polymer component SC6260, about 1 part of heat stability additive HT1, about 40 parts of a Minex Nepheline Syenite filler material, and about 1 part of silane coupling agent FI69 which is commercially available from Degussa Corp. located in Parsippany, N.J., and about 1 part of peroxide DBPH-50.

Compounding of the silicone rubber compositions can be achieved by mixing the constituents thereof in an internal mixer such as a doughmixer or Banbury type mixer which provides additional shear through action of the ram. Typically, the vinyl-containing silicone polymer component is loaded first, followed by the liquid components, filler material, and other additives, although this sequence can be modified to provide more initial shear by partial addition of the filler material up front. Incorporation of the high surface area reinforcing filler material is usually the rate controlling step in achieving satisfactory mix. In-situ filler material treatment usually requires a cook or heating cycle which also serves to devolitilize the compound and stabilize properties. Pretreated filler material and devolitilized polymer component allows the use of a “cold mix” to similarly achieve stable properties and is generally a more cost effective process.

Freshening is the process of mechanically plasticizing or softening a silicone rubber composition to develop consistency in fabrication. Even with the use of process aids, most silicone rubber compositions show some degree of structure with time and benefit from freshening prior to fabrication. Silicone rubber compositions are easily freshened on a two roll rubber mill equipped with a scraper blade on the fast roll to facilitate stock removal. A speed ratio on the rolls of 1.2-1.4 to 1 is desirable to shear the rubber as it passes through the nip which helps to promote good dispersion. Milling is also utilized to add minor ingredients such as pigment and catalyst to the composition as it provides temperature control to prevent premature volitilization or decomposition of the catalyst. An example of one mill mix cycle is set forth below:

Begin with a clean mill and turn on the cooling water.

Set the nip spacing to approximately ¼″ and pass the compound through the nip several times.

Gradually tighten the nip until the compound transfers to the fast roll. Continue milling until the material forms a smooth band which indicates the material is freshened.

When mixing additives on the mill, first fully freshen the base compound, and then add the other components. Cross-blend by removing the material from the mill using the scraper blade or a mill knife and turning 90° before feeding it back through the nip. Cross-blending a minimum of 10 times will assure a uniform mix.

When blending compounds of different consistencies, freshen the firmer stock first, and then add the softer stock and cross-blend. Prefreshening pigment masterbatches is recommended before adding to the base compound.

The mill should be cleaned prior to changing the compound formulation. A stiff; highly filled silicone stock makes a good cleanout compound for removing any material that may have adhered to the mill rolls from prior batches.

The silicone rubber compositions described herein can be fabricated into rubber articles by all standard methods for thermoset elastomers including, but not limited to, molding, extrusion, and calandering. The following discussion briefly summarize some of the various fabrication techniques.

Compression molding is the most widely used method for molding silicone rubber parts. The stock is usually preformed first to the approximate size and weight of the final part and then placed in the heated cavity of the mold where it is cured under heat and pressure.

Transfer molding is a process by which uncured silicone rubber is transferred from a holding vessel (transfer pot) to the mold cavities using a hydraulically operated piston. Transfer molding is especially conducive to multi-cavity designs and can produce nearly flashless parts.

Silicone rubber has a low relative viscosity and fast cure rate and thus makes it a suitable material for injection molding. Although the screw can be directly fed with preformed strip, many prefer to use a stuffer box which insures constant feed and minimizes handling of the uncured compound. Injection molding cure cycles are typically in the range of 0.5-3 minutes depending on part size, and mold shrinkage tends to be lower than other molding methods due to high injection pressures. Balanced gates and venting are required to avoid air entrapment and insure complete fill in multi cavity molds.

Extrusion is the fabricating technique to produce continuous profile shapes and preforms such as tubing and wire & cable insulation. Standard rubber extruders with water cooling and roller feeds can be used to fabricate silicone rubber. The barrel should be constructed of abrasion resistant surface hardened steel such as nitrided 4140 to minimize wear. Typically, the screw should have a compression ratio in the range of 2:1 to 4:1 and an L/D (length/diameter) ratio of 8:1 to 12:1. Deep flights in the feed section facilitate feeding of the compound. Stainless steel screens of 40 to 150 mesh are recommended to remove contamination, increase back pressure, reduce porosity, and provide better dimensional control.

Extruded profile may be cured by hot air vulcanization (HAV), steam vulcanization (CV) or liquid-medium cure. HAV consists of a heated tunnel through which the profile is fed continuously on a moving conveyor. Air temperature reaches 600° F. to 1200° F., and cure times are usually short, on the order of 3 to 12 seconds. The recommended curing agents are DCBP-50 or addition cure, both of which provide rapid cure with no porosity.

Steam cure commonly refers to the steam curing systems used by the wire and cable industry and consists of chambers 4″-6″ in diameter and 100-150 feet in length. Steam pressure varies from 50 psig to 225 psig depending on wall thickness of the insulation and line speed. A typical cure with benzoyl peroxide is 13 seconds or 400 feet/minute at 125 psig.

For liquid-medium cure, continuous lengths of extruded profile are fed into a bath of molten material (salt or lead) which cures the extrudate. This technique requires DCBP-50 to prevent porosity.

Calandering is the process for producing long runs of uniform thickness sheets of silicone rubber either unsupported or on a fabric backing. A standard 3 or 4 roll calander with linear speed range of 2 to 10 feet/minute is typical for silicone rubber. Firm compound with good green strength and resistance to overmilling works the best for calandering. Soft stocks should be aged a minimum of 24 hours after milling to build up some structure prior to calandering. Unsupported sheet can be partially cured by passing over a heated drum or through an HAV unit and then post cured in an air circulating oven. Both supported and unsupported sheet can also be cured on a roll in a steam autoclave.

Oven curing or post baking is the process of heating cured silicone rubber parts in an oven to remove volatiles and peroxide decomposition by-products. This process improves dimensional stability and high temperature performance. It is recommended for parts cured with either 2,4 dichlorobenzoyl peroxide or benzoyl peroxide since acidic by-products of these materials cause reversion at high temperature unless removed by post baking.

Electric and indirectly fired gas air circulating ovens have been used successfully for post baking silicone rubber parts. For example, fresh air flow can be maintained at a minimum of about 450 cubic feet per minute per pound of silicone rubber, and parts should be supported on open trays to maximize exposure. Generally, post bake temperature should be a minimum of 50° F. higher than the service temperature of the part. Sections thicker than 0.075″ may require a stepped post bake (gradually increasing temperatures) to avoid sponging of the part.

While the invention has been illustrated and described in detail in the drawings and the foregoing description, such an illustration and description is to be considered exemplary and not restrictive in character, it being understood that only illustrative embodiments have been shown and described and that all changes and modifications within the spirit of the invention are desired to be protected.

There are a plurality of advantages of the present invention arising from the various features of the rubber compositions described herein. It will be noted that alternative embodiments of the rubber compositions of the present invention may not include all of the features described but yet still benefit from at least some of the advantages of such features.

What is claimed is:

1. A silicone rubber composition, comprising:
a silicone polymer component; and
a filler material which is substantially devoid of free-SiO₂.

2. The silicone rubber composition of claim 1, wherein:
said filler material includes Nepheline Syenite.

3. The silicone rubber composition of claim 1, wherein:
said silicone polymer component contains vinyl radicals.

4. The silicone rubber composition of claim 1, further comprising:
a heat stability additive.

5. The silicone rubber composition of claim 4, wherein:
said heat stability additive is selected from the group consisting of, iron oxides, titania, cerium oxides, fatty acid cerium salts, magnesium oxides, manganese oxides, and metallic zirconates.

6. A silicone rubber composition, comprising:
a silicone polymer component; and
Nepheline Syenite.

7. The silicone rubber composition of claim 6, wherein:
said silicone polymer component contains vinyl radicals.

8. The silicone rubber composition of claim 6, further comprising:
a heat stability additive.

9. The silicone rubber composition of claim 8, wherein:
said heat stability additive is selected from the group consisting of, iron oxides, titania, cerium oxides, fatty acid cerium salts, magnesium oxides, manganese oxides, and metallic zirconates.

10. A silicone rubber composition which is substantially devoid of free-SiO₂.

11. The silicone rubber composition of claim 10, comprising:
a filler material.

12. The silicone rubber composition of claim 11, wherein:
said filler material includes Nepheline Syenite.

13. The silicone rubber composition of claim 10, comprising:
a heat stability additive.

14. The silicone rubber composition of claim 13, wherein:
said heat stability additive includes a material selected from the group consisting of iron oxides, titania, cerium oxides, fatty acid cerium salts, and metallic zirconates.

15. A silicone rubber composition, comprising:
a silicone polymer component; and
a filler material which includes Nepheline Syenite.

16. The silicone rubber composition of claim 15, comprising:
a heat stability additive.

17. A silicone rubber composition which (i) is substantially devoid of free SiO₂ and (ii) includes a substantial amount of (A) KAISi₃O₈ and (B) a silicone polymer component.

18. A method of producing a silicone rubber composition which includes a silicone polymer component, comprising:
adding Nepheline Syenite to said silicone polymer component.

19. The method of claim 18, further comprising:
adding a heat stability additive to said silicone polymer component.
